(19) United States
(12) Patent Application Publication
(10) Pub. No.: US 2007/0133905 A1
(43) Pub. Date: Jun. 14, 2007

(54) IMAGE INTERPOLATION METHOD AND DEVICE

(75) Inventor: Chen-Chien Chung, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BEYOND INNOVATION TECHNOLOGY CO., LTD., Taipei (TW)

(21) Appl. No.: 11/423,743

(22) Filed: Jun. 13, 2006

(30) Foreign Application Priority Data
Dec. 12, 2005 (TW) 94143825

(51) Int. Cl. G06K 9/32

(52) U.S. Cl. 382/300

(57) ABSTRACT

The invention relates to an image resolution interpolation method utilizing two reference pixels, two equations and a compensation equation to determine an interpolation pixel. The two equations respectively determine two right weight values for the two reference pixels, and the invention more uses a product of the two right weight values, the compensation equation, and a difference which is between two reference pixels to adjust the image. The invention can be applied to an image of any size and maintains the sharpness of the image, wherein the image will not become blurred due to the interpolation.

### BACKGROUND OF THE INVENTION

1. Field of the Invention

The invention relates to an image interpolation method and device, and more particularly to an image resolution interpolation method and device utilizing cubic equations and reference points reducing slope to increase image quality and reduce required hardware resources.

2. Description of the Related Art

In present display devices, the electronic screen system has been popularly applied in a plurality product, such as digital cameras, LCD TVs, LCD displays and the like. However, when the resolution of an image source differs from the resolution of the image display, an image resolution adjustment device is desirable to change the resolution of the image source to meet the resolution of the image display.

If the resolution of the input image is 640×480 (VGA) and the output resolution requirement is 1024×768 (XGA mode), the resolution of the image must be increased. If the resolution of the input image is 1280×1024 (SXGA) and the output resolution requirement is 1024×768 (XGA mode), the resolution of the image must be decreased. To strike a balance between quality and cost, resolution processing is critical. Common used image resolution interpolation processing methods, include Bilinear, Cubic, Besier, Natural, Catmull-Rom, Hermite and similar.

### BRIEF SUMMARY OF THE INVENTION

The invention provides an image interpolation converting device to meet the function of the system client.

The invention further provides an image resolution interpolation method and device utilizing cubic equations and a slope between two reference points to reduce required hardware resources.

To achieve the described goal, the invention utilizes two reference points p(1) and p(2) and provides cubic equations: v1(t)=2tˆ3−3tˆ2+1; v2(t)=−2tˆ3+3tˆ2; v3(t)=tˆ3−2tˆ2+t; v4(t)=tˆ3−tˆ2. The slope factor T is equal to [p(1)−p(2)]. The interpolation point pi(t) is equal to v1(t)*p(1)+v2(t)*p(2)+T*(v3(t)+v4(t)) and pi(t) is limited within a valid range, for example, pi(t) is limited within the range between 0 and 255 as the interpolation point pi(t) is an 8-bit value. The interval gain factor, t, is evaluated based on the input image resolution and the output display resolution, for example, t is equal to 0.625 when the resolution is changed from 640 points to 1024 points. The image resolution interpolation method of the invention can scale the image at will preserve the sharpness of the image, and the image will not become blurred due to the interpolation. The invention provides better performance and requires fewer hardware resources than the conventional interpolation method, such as Bilinear, Cubic, Besier, Natural, Catmull-Rom, Hermite and the like.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of an embodiment of the interpolation method of the invention.

FIG. 2 is a curve diagram of the equations defined by the invention.

FIG. 3 is a block diagram of an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

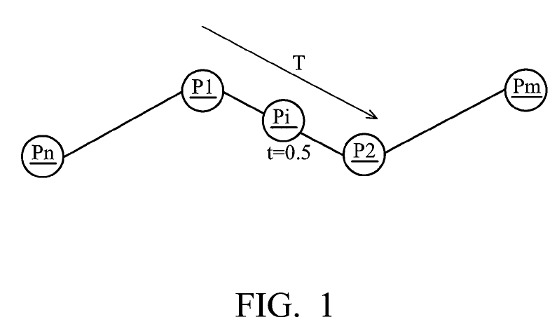

FIG. 1 is a schematic diagram of an embodiment of the interpolation of the invention. P1 and P2 are pixels of the input image. T is a vector generated by P1 and P2. Pi is the image interpolation point evaluated by the method of the invention and t is the interval gain factor of the interpolation point.

Three cubic equations in one unknown are defined as following:
E1(t)=2tˆ3−3tˆ2+1 eq.1
E2(t)=−2tˆ3+3tˆ2 eq.2
E3(t)=2tˆ3−3tˆ2+t eq.3

The slope factor is defined as following:
T=V(P1)−V(P2), eq.4
wherein V(P1) is the image value of the pixel P1 and V(P2) is the image value of the pixel P2.

The interpolation point Pi is defined as followings:
Pi(t)=E1(t)*V(P1)+E2(t)*V(P2)+(V(P1)V(P2))*E3(t) eq.5

The interval gain factor, t, is evaluated based on the input image resolution and the output resolution of the display, for example, t is equal to 0.625 when the resolution is changed from 640 points to 1024 points. According to the described equations, the interpolation point Pi can be represented by the following equation:
Pi(t)=V(P1)*(2tˆ3−3tˆ2+1)+V(P2)*(−2tˆ3+3tˆ2)+T(2tˆ3−3tˆ2+t) eq.6

The interpolation point Pi(t) is limited within the range between 0 and 255 as the interpolation point Pi(t) is an 8-bit value. Thus, the input image can be scaled in any resolution by adjusting the interval gain factor, t, and the reference points, such as P1 and P2. In FIG. 1, the interval gain factor, t, is equal to 0.5.

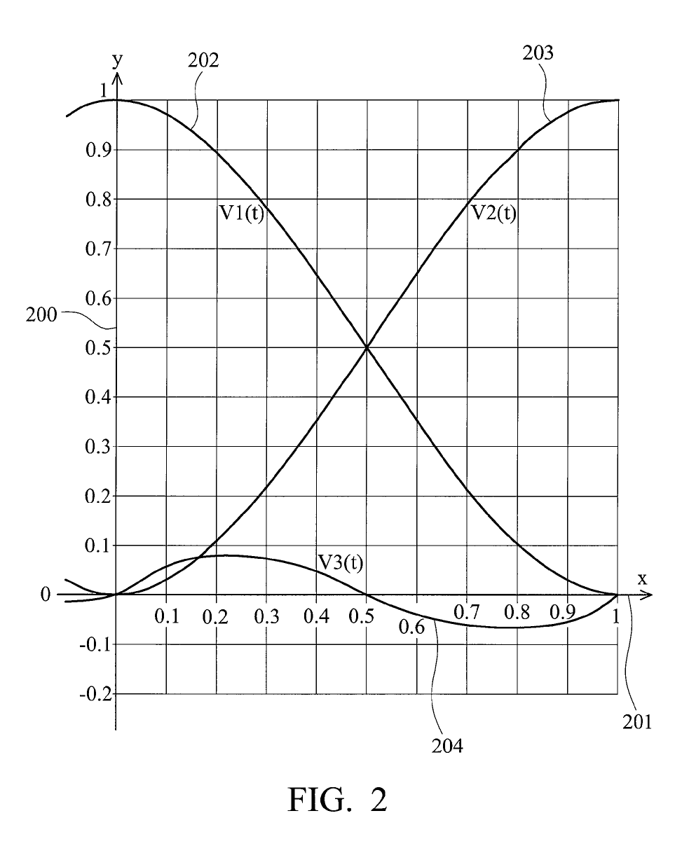

Please refer to FIG. 2. FIG. 2 is a curve diagram of the equations defined by the invention. The vertical axis y represents the variable 200. The horizontal axis represents the variable t 200. Curve 202 represents a set of the domain and range of the equation E1(t). Curve 203 represents a set of the domain and range of the equation E2(t). Curve 203 represents a set of the domain and range of the equation E3(t). Curve 204 represents a set of the domain and range of the equation E4(t).

According to the described, it is clear that the spirit of the invention is that when the interpolation point Pi is closer to the pixel P1 than the pixel P2, the weighted value of the pixel P1 generated by the equation E1(t) is greater than the weighted value of the pixel P2 generated by the equation E2(t). On the other hand, when the interpolation point Pi is closer to the pixel P2 than the pixel P1, the weighted value of the pixel P2 generated by the equation E2(t) is greater than the weighted value of the pixel P1 generated by the equation E1(t). In other words, when t is more than 0 and less than 0.5, E1(t) is more than 0.5 and E2(t) is less than 0.5, and when t is more than 0.5 and less than 1, E2(t) is more than 0.5 and E1(t) is less than 0.5. Furthermore, the sum of E1(t) and E2(t) is equal to 1. Definitely, the equations E1(t) and E2(t) are cubic equations in one unknown and they are only examples of the invention, and the invention is not limited thereto. For example, the equations E1(t) and E2(t) could be quadratic equations in one unknown or biquadratic equations in one unknown, wherein the equation E1(t) and the equation E2(t) only correspond with the described limitations.

Furthermore, the compensation equation E3(t) has to conform with that the equation E3(t) equals 0 at t=0 and t=1. Thus, it can conform with that the bounded condition when t is equal to 0, Pi(t) is equal to V(P1) and when t is equal to 1, Pi(t) is equal to V(P2). And the constant value of the equation E3(t) is equal to 0 because E3(0) is equal to 0. Besides, the function value of the compensation equation is bilateral symmetry of a line t=0.5. The domain of equation E3(t) is between 0 and 1 and the range of equation E3(t) is between −1 and 1. Thus, an average value of the values of the interpolation points is located between the pixels P1 and P2 and each value of interpolation point is located between V(P1) and V(P2). Moreover, one feature of the compensation equation E3(t) is that at least one solution is at the interval between 0 and 1 when the compensation equation E3(t) is equal to 0.

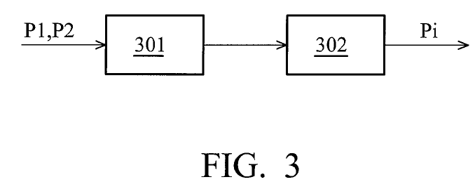

The method of the invention can be implemented by hardware, software, firmware or the combination thereof. Please refer to FIG. 3. FIG. 3 is a block diagram of an embodiment of an image resolution interpolation device of the invention. The image resolution interpolation device comprises an input unit 301 and a computing unit 302 for transforming the resolution of the image from a first resolution to a second resolution. The input unit 301 receives a first image value V(P1) of pixel P1 and a second image value V(P2) of pixel P2. The computing unit 302 evaluates interpolation values Pi (t) based on a first equation in one unknown, a second equation in one unknown, a third equation in one unknown and a ratio of the second resolution to the first resolution and generates an image with the second resolution based on the interpolation values Pi(t).

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image interpolation method, comprising:
receiving a first image value V(P1), a second image value V(P2) and a interval gain factor t;
providing a first cubic equation in one unknown E1(t), a second cubic equation in one unknown E2(t) and a compensation equation in one unknown E3 (t); and
evaluating an interpolation image value Pi(t) based on a first product of V(P1) and E1(t), a second product of E1(t) and E2(t) and a third product of E3 (t) and a difference between the first product and the second product;
wherein when t is more than 0 and less than 0.5, E1(t) is more than 0.5, and when t is more than 0.5 and less than 1, E1(t) is less than 0.5; when t is more than 0 and less than 0.5, E2(t) is less than 0.5, and when t is more than 0.5 and less than 1, E2(t) is more than 0.5; when t is equal to 0 or 1, E3(t) is equal to 0.

2. The method as claimed in claim 1, wherein E3(t) is a cubic equation in 1 unknown.

3. The method as claimed in claim 1, wherein the sum of E1(t) and E2(t) equals 1.

4. The method as claimed in claim 1, wherein |E3(t)| is bilateral symmetric to a line t=0.5.

5. The method as claimed in claim 2, wherein |E3(t)| is bilateral symmetric to a line t=0.5.

6. The method as claimed in claim 3, wherein |E3(t)| is bilateral symmetric to a line t=0.5.

7. The method as claimed in claim 1, wherein when t is 0 to 1, E3(t) is between −1 and 1.

8. The method as claimed in claim 2, wherein when t is 0 to 1, E3(t) is between −1 and 1.

9. The method as claimed in claim 3, wherein when t is 0 to 1, E3(t) is between −1 and 1.

10. The method as claimed in claim 1, wherein E1(t)=2tˆ3−3tˆ2+1.

11. The method as claimed in claim 2, wherein E1(t)=2tˆ3−3tˆ2+1.

12. The method as claimed in claim 3, wherein E1(t)=2tˆ3−3tˆ2+1.

13. The method as claimed in claim 1, wherein E2(t)=−2tˆ3+3tˆ2.

14. The method as claimed in claim 2, wherein E2(t)=−2tˆ3+3tˆ2.

15. The method as claimed in claim 3, wherein E2(t)=−2tˆ3+3tˆ2.

16. The method as claimed in claim 1, wherein E3(t)=2tˆ3−3tˆ2+t.

17. The method as claimed in claim 2, wherein E3(t)=2tˆ3−3tˆ2+t.

18. The method as claimed in claim 3, wherein E3(t)=2tˆ3−3tˆ2+t.

19. The method as claimed in claim 1, wherein the compensation has at least three roots when E3(t)=0.

20. An image interpolation method, comprising:
receiving a first image value V(P1), a second image value V(P2) and a interval gain factor t;
providing a first cubic equation E1(t), a second cubic equation E2(t) and a compensation equation E3(t); and
evaluating an interpolation image value Pi(t) by an equation:
Pi(t)=V(P1)*E1(t)+V(P2)*E2(t)+(V(P1)−V(P2))*E3(t),
wherein when t is more than 0 and less than 0.5, E1(t) is more than 0.5, and when t is more than 0.5and less than 1, E1(t) is less than 0.5; when t is more than 0 and less than 0.5, E2(t) is less than 0.5, and when t is more than 0.5 and less than 1, E2(t) is more than 0.5; when t is equal to 0 or 1, E3(t) is equal to 0.

21. The method as claimed in claim 20, wherein E3(t) is a cubic equation in 1 unknown.

22. The method as claimed in claim 20, wherein the sum of E1(t) and E2(t) equals 1.

23. The method as claimed in claim 20, wherein |E3(t)| is bilateral symmetric to a line t=0.5.

24. The method as claimed in claim 21, wherein |E3(t)| is bilateral symmetric to a line t=0.5.

25. The method as claimed in claim 22, wherein |E3(t)| is bilateral symmetric to a line t=0.5.

26. The method as claimed in claim 20, wherein a range of value of E3(t) is between −1 and 1 when t is more than 0 and less than 1.

27. The method as claimed in claim 21, wherein a range of value of E3(t) is between −1 and 1 when t is more than 0 and less than 1.

28. The method as claimed in claim 22, wherein a range of value of E3(t) is between −1 and 1 when t is more than 0 and less than 1.

29. The method as claimed in claim 20, wherein a constant value of the compensation equation E3(t) is equal to 0.

30. The method as claimed in claim 21, wherein a constant value of the compensation equation E3(t) is equal to 0.

31. The method as claimed in claim 22, wherein a constant value of the compensation equation E3(t) is equal to 0.

32. An image resizing device for changing the resolution of an image from a first resolution to a second resolution, comprising:
an input unit receiving a first image value and a second image value; and
a computing unit having a first equation in one unknown, a second equation in one unknown and a compensation equation in one unknown to acquire an image data with the second resolution based on a ratio of the first resolution and the second resolution;
wherein when a first variable of the first equation is between 0 and 0.5, a first function value of the first cubic equation is more than 0.5, and when the first variable is more than 0.5 and less than 1, the first function value of the first cubic equation is less than 0.5; when a second variable of the second cubic equation is more than 0 and less than 0.5, a second function value of the second cubic equation is less than 0.5, and when the second variable of the second cubic equation is more than 0.5 and less than 1, the second function value of the second cubic equation is more than 0.5; when a third variable of the compensation equation is equal to 0 or 1, a function value of the compensation equation is equal to 0.

33. The device as claimed in claim 31, wherein the compensation equation is a cubic equation in one unknown.

34. The device as claimed in claim 31, wherein the sum of the first cubic equation and the second cubic equation is 1.

35. The device as claimed in claim 31, wherein an absolute value of the function value of the compensation equation is bilateral symmetric to a line t=0.5.

36. The device as claimed in claim 32, wherein an absolute value of the function value of the compensation equation is bilateral symmetric to a line t=0.5.

37. The device as claimed in claim 33, wherein an absolute value of the function value of the compensation equation is bilateral symmetric to a line t=0.5.

38. The device as claimed in claim 31, wherein when the third variable of the compensation equation is 0 to 1, the function value of the compensation equation is between −1 and 1.

39. The device as claimed in claim 32, wherein when the third variable of the compensation equation is 0 to 1, the function value of the compensation equation is between −1 and 1.

40. The device as claimed in claim 33, wherein when the third variable of the compensation equation is 0 to 1, the function value of the compensation equation is between −1 and 1.

41. The device as claimed in claim 31, wherein the first cubic equation is 2tˆ3−3tˆ2+1.

42. The device as claimed in claim 32, wherein the first cubic equation is 2tˆ3−3tˆ2+1.

43. The device as claimed in claim 33, wherein the first cubic equation is 2tˆ3−3tˆ2+1.

44. The device as claimed in claim 31, wherein the compensation equation is 2tˆ3−3tˆ2.

45. The device as claimed in claim 32, wherein the compensation equation is 2tˆ3−3tˆ2.

46. The device as claimed in claim 33, wherein the compensation equation is 2tˆ3−3tˆ2.

47. The device as claimed in claim 31, wherein the compensation equation is 2tˆ3−3tˆ2+t.

48. The device as claimed in claim 32, wherein the compensation equation is 2tˆ3−3tˆ2+t.

49. The device as claimed in claim 33, wherein the compensation equation is 2tˆ3−3tˆ2+t.
